(19) United States
(12) Patent Application Publication
(10) Pub. No.: US 2004/0030868 A1
(43) Pub. Date: Feb. 12, 2004

(54) Interrupt-free interface apparatus between modem processor and media processor and method thereof

(75) Inventor: You-Suk Sew, Gunpo (KR)

Correspondence Address: JONATHAN Y. KANG, ESQ., LEE & HONG P.C., 14th Floor, 801 S. Figueroa Street, Los Angeles, CA, 90017, US

(73) Assignee: LG Electronics Inc.

(21) Appl. No.: 10/624,405

(22) Filed: Jul. 21, 2003

(30) Foreign Application Priority Data
Jul. 22, 2002 (KR) 42994/2002

(51) Int. Cl. G06F 15/00; G06F 9/44; G06F 9/00

(52) U.S. Cl. 712/220

(57) ABSTRACT

An interrupt-free interface apparatus between a modem processor and a media processor and a method thereof comprises a modem processor for processing data received through a wired or a wireless channel from outer side and for performing various controls according to the data receipt; a multimedia application processor (MAP) for processing information such as voice/sound/moving picture which will be provided to a user; and a dual access memory for storing an indicator and an index for identifying normal transmitting/receiving status of the data and the number of data in case that the data is written or read between the modem processor and the MAP with a predetermined period, to solve problems such as processing speed lowering generated in a case that a processor becomes to have larger processing load so as not to process other task when the interrupt having higher priority is generated frequently between the modem processor and the MAP, and therefore, data processing function between the two processors can be improved and power consumption of the terminal can be reduced.

### BACKGROUND OF THE INVENTION

1. Field of the Invention

The present invention relates to a terminal for picture communication, and particularly, to an interrupt-free interface apparatus and a method thereof between a modem processor and a media process which are able to reduce problems in inter-communication and to improve processing function between the two processors, by exchanging data generated between a modem processor and a multimedia application processor (MAP) in an intelligent addressing method.

2. Description of the Background Art

Generally, a multimedia terminal comprises a modem processor for processing data of a communication channel and performing controls according to the data, and a MAP for processing image/voice.

At that time, the two processors generate interrupts to be suitable for data rate provided to the communication channel to notify each other that there are the data to be processed between the two processors.

Originally, the interrupt is to notify the counterpart processor of an event which is generated irregularly, and the counterpart processor processes the required interrupt according to the priority order. That is, when the interrupt is generated from one processor, the counterpart processor processes the interrupt preferentially after ceasing the task presently performed.

FIG. 1 is a block diagram showing an interrupt-free interface apparatus between the modem processor and the MAP according to the conventional art.

As shown therein, the interrupt-free interface apparatus between the modem processor and the MAP comprising: a modem processor 110 for processing the data received through a wired or wireless channel from outside and for performing controls according to data receipt; a MAP 130 for processing image/voice information which will be provided to a user; and a dual access memory 120 for storing data received/transmitted between the modem processor 110 and the MAP 130 by the interrupt.

The data stored in the dual access memory 120 is processed preferentially by the interrupt between the modem processor 110 and the MAP 130 and inputted into the counterpart processor. Also, data exchange is performed between the modem processor 110 and the MAP 130 due to the interrupt generation, and in this case, generation period of the interrupt is about 10 ms or 20 ms according to size of data unit.

Hereinafter, operation of the interrupt-free interface apparatus between the modem processor and the MAP according to the conventional art will be described as follows.

First, the modem processor 110 writes the data received through the wired or wireless channel from outside on the dual access memory 120.

After that, the modem processor 110 generates the interrupt so that the MAP 130 can read the data written on the dual access memory 120. Then, the MAP 130 ceases the task previously performed and reads the data from the dual access memory 120 according to the interrupt command signal.

On the other hand, in case that the MAP 130 generates the interrupt in order to transmit the data from the MAP 130 to the modem processor 110, the data exchange is made toward the opposite direction of the above process.

However, in processing the task between the processors in the interrupt-free interface apparatus between the modem processor and the MAP according to the conventional art, the two processors make each other process excessive task, and therefore, the interrupt is generated between the two processors frequently. Therefore, when the interrupt having higher priority is generated frequently, the counterpart processor becomes to have a large processing load so as not to process other task. And accordingly, problems such as processing speed lowering may be generated.

Also, in case that the interrupt having higher priority is generated frequently, the process of the task which is previously performed before the interrupt is delayed due to additional operation according to the interrupt, and consequently, the entire function of the processor is lowered.

Also, in case that the interrupts having the high priority of same level are generated simultaneously, wrong operation may be generated between the two processors, and accordingly, the power consumption is increased.

### SUMMARY OF THE INVENTION

Therefore, an object of the present invention is to provide an interrupt-free interface apparatus between a modem processor and a multimedia application processor (MAP) in a terminal for picture communication in a wired or a wireless communication method which is able to improve processing functions of the two processor and to reduce power consumption of the terminal itself by using an intelligent addressing method for processing data between the modem processor and the MAP instead of using an interrupt method that generates interrupt frequently between the two processors.

To achieve the object of the present invention, as embodied and broadly described herein, there is provided an interrupt-free interface apparatus between the modem processor and a media processor comprising: a modem processor for processing data received through a wired or a wireless channel from outside and performing various controls according to the data; a multimedia application processor for processing information such as voice/sound/moving picture which will be provided to user; and a dual access memory for storing an indicator and an index for identifying normal transmission/receipt status of the data and the number of data in case that the data is written or read between the modem processor and the MAP by constant period. Herein, the dual access memory comprises a data storing area for storing the data transmitted/received between the modem processor and the MAP; an indicator storing area for storing the indicator representing storing unit/reading unit of the data stored in the data storing area; and an index storing area for storing the index representing the write/read status of the data.

To achieve the object of the present invention, there is provided an interrupt-free interface method between the modem processor and the media processor comprising: a first step of writing/reading the data on the dual access memory from the modem processor or the MAP after initializing the dual access memory; a second step of deciding whether the data is normally written/read on a predetermined position of the dual access memory or not; a third step of examining the storing area of the dual access memory in case that a predetermined time which is set in advance passed over; a fourth step of reading the data stored in the dual access memory whenever a change is generated on the indicator as a result of the examination; and a fifth step of deciding whether the data is read normally or not.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram showing an interrupt-free interface apparatus between a modem processor and a MAP according to the conventional art;

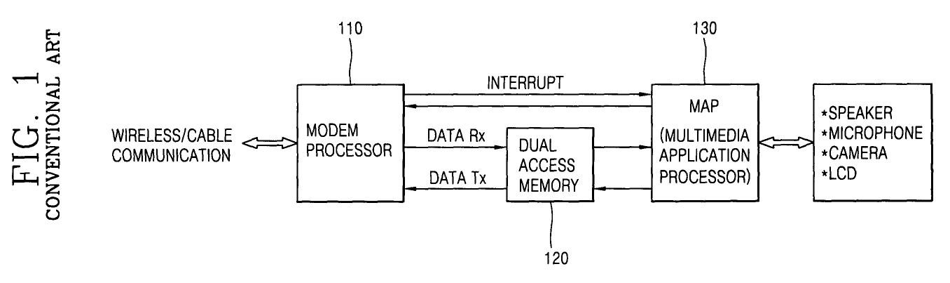

FIG. 2 is a block diagram showing an interrupt-free interface apparatus between a modem processor and a MAP according to the present invention; and

FIG. 3 is a detailed view showing a dual access memory in FIG. 2.

### DETAILED DESCRIPTION OF THE PREFERRED EMBODIMENTS

Reference will now be made in detail to the preferred embodiments of the present invention, examples of which are illustrated in the accompanying drawings.

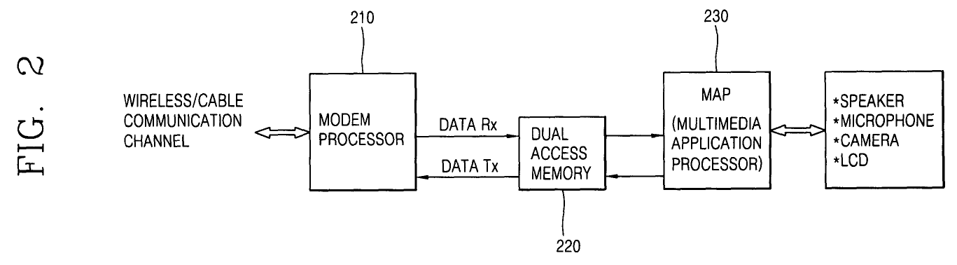

FIG. 2 is a block diagram showing an interrupt-free interface apparatus between a modem processor and a MAP according to the present invention.

As shown therein, the interrupt-free interface apparatus between the modem processor and the MAP according to the present invention comprises: a modem processor 210 for processing data received through a wired or a wireless channel from outer side and performing various controls according to the data receipt; a MAP 230 for processing information such as voice/sound/moving picture which will be provided to user; and a dual access memory 220 for storing a predetermined value representing writing univreading unit of transmitted data and a predetermined value representing writing status/reading status of the data in case that the data is transmitted/received between the modem processor 210 and the MAP 230 by predetermined periods.

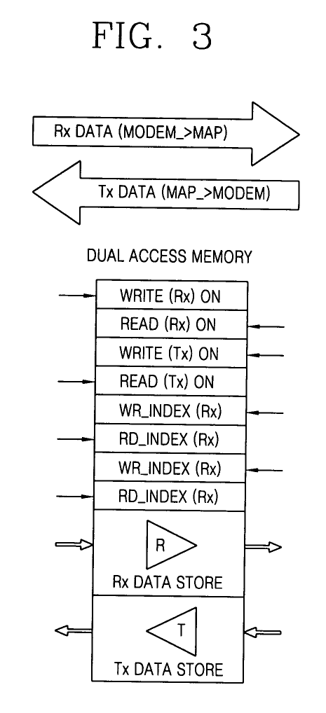

FIG. 3 is a detailed view showing the dual access memory shown in FIG. 2.

As shown therein, the dual access memory 220 comprises: a data storing area for storing the data transmitted/received between the modem processor 210 and the MAP 230; an indicator storing area for storing an indicator representing the storing univreading unit of the data; and an index storing area for storing an index representing the storing status/reading status of the data.

The interrupt-free interface method between the modem processor and the MAP according to the present invention comprises: a first step of initializing the dual access memory and writing Rxdata on the dual access memory from the modem processor; a second step of deciding whether the Rxdata is normally written on a predetermined position of the dual access memory or not; a third step of examining the storing areas of the dual access memory in case that a predetermined time which is set in advance passed over; a fourth step of reading the Rxdata stored in the dual access memory whenever the predetermined value (Write(Rx)on) representing the writing status/reading status of the Rxdata is changed as a result of examination; and a fifth step of deciding whether the Rxdata is normally read or not.

Hereinafter, referring to FIGS. 2 and 3, operations and effects of the interrupt-free interface apparatus between the modem processor and the MAP according to the present invention will be described as follows.

First, after initializing the dual access memory 220, the modem processor 210 and the MAP 230 change the data with each other in an intelligent addressing method instead of the conventional interrupt method.

A case that the modem processor 210 transmits the data received through the wired and wireless channel from the outer side to the MAP 230 will be described as follows.

The modem processor 210 writes the Rxdata on the dual access memory 220, and sets (or resets) the indicator (Write(Rx)on) in order to represent that the data is normally written on a predetermined position of the dual access memory 220. At the same time, the dual access memory 220 increases the value of index (Wr_Index(Rx)) by 1 in order to represent that the data of one unit is normally stored in the dual access memory 220.

After that, the MAP 230 examines the storing areas of the dual access memory in case that the predetermined time which is set in advance passed over.

As a result of the examination, when the change is generated on the value of indicator (Write(Rx)on), the MAP 230 reads the data stored in the dual access memory 220, and then, sets (or resets) the indicator (Read(Rx)on) in order to represent that the data is read normally. Herein, the indicators (Write(Rx)on, Read(Rx)on) mean the status representing whether the data is normally written or read on the dual access memory 220 or not.

On setting (or resetting) the indicator (Read(Rx)on), the dual access memory 220 increases the value of index (Rd-Index(Rx)) by 1 in order to represent that the data of one unit is normally read from the dual access memory 220. Herein, the index (Wr_Index(Rx), Rd-Index(Rx)) means the number of data written or read on the dual access memory 220.

In case that the Rxdata is transmitted normally, difference between the index (Wr_Index(Rx)) value and the index (Rd_Index(Rx)) is 1 or 0. Therefore, the modem processor 210 and the MAP 230 identify the difference value between the indexes (Wr_Index(Rx) and Rd_Index(Rx)) to decide whether or not the data is normally transmitted/received.

After that, the modem processor 210 and the MAP 230 identify the values of indicators (Write(Rx)on and Read(Rx)on) representing the status of the data stored in the dual access memory 220 and the values of indexes (Wr_Index(Rx) and Rd_Index(Rx)) sequentially, and therefore, the above process is performed repeatedly.

On the other hand, in case that the MAP 230 transmits the Txdata to the modem processor 210, the data exchange between the two processors is made by using the values of indicators (Write(Tx)on and Read(Tx)on) and values of indexes (Wr_Index(Tx) and Rd_Index(Tx)) of the dual access memory 220.

The above indexes (Wr_index(Rx), Rd_index(Rx), Wr_index(Tx) and Rd_index(Tx) are all the continuously increased register values of Modulo N value.

As described above, according to the interrupt-free interface apparatus between the modem processor and the media processor of the present invention, the data can be exchanged between the two processors by using values of the indicators (Write(Rx)on, Read(Rx)on, Write(Tx)on and Read(Tx)on) and indexes (Wr_Index(Rx), Rd_Index(Rx), Wr_Index(Tx) and Rd_index(Tx)) in the dual access memory 220 through the intelligent addressing method instead of using the interrupt method.

Also, according to the present invention, the number of data stored in the dual access memory 220 can be identified using the values of indexes, and therefore, the respective processor is able to control the examination period for transmitting/receiving the data.

As described above in detail, the present invention does not use the interrupt method when the data is exchanged between the two processors to reduce the load of the processors, and therefore, the function of terminal can be improved and the power consumption can be reduced.

Also, according to the present invention, the calculation processing amount according to the interrupt service routine can be reduced, and therefore, the respective processor can be applied to a task requiring the interrupt and the load of a scheduler in a real-time operating system (OS) can be reduced.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An interrupt-free interface apparatus between a modem processor and a MAP comprising:
a modem processor for processing data received through a wired or a wireless channel from outer side and for performing various controls according to the data receipt;
a multimedia application processor (MAP) for processing information such as voice/sound/moving picture which will be provided to a user; and
a dual access memory for storing an indicator and an index for identifying normal transmitting/receiving status of the data and the number of data in case that the data is written or read between the modem processor and the MAP with a predetermined period.

2. The apparatus of claim 1, wherein the indicator is stored in the dual access memory in order to identify whether the data is normally written or read or not, in case that the data is written or read between the modem processor and the MAP.

3. The apparatus of claim 1, wherein the index represents the number of data which is written or read and is stored in the dual access memory in case that the data is written or read between the modem processor and the MAP.

4. The apparatus of claim 1, wherein the respective modem processor and the MAP identify the indicator representing the normal transmitting/receiving status of the data and the index representing the number of data with a predetermined period to decide whether the data is normally written or read or not.

5. The apparatus of claim 1, wherein the dual access memory comprises:
a data storing area for storing data transmitted/received between the modem processor and the MAP;
an indicator storing area for storing the indicator representing storing unit/reading unit of the data; and
an index storing area for storing the index representing the writing status/reading status of the data.

6. The apparatus of claim 5, wherein the data storing area comprises two areas for storing the data.

7. The apparatus of claim 5, wherein the indicator storing area comprises four areas for storing the data.

8. The apparatus of claim 5, wherein the index storing area comprises four storing areas for storing the data.

9. An interrupt-free interface method between a modem processor and a MAP comprising:
a first step of writing or reading data on a dual access memory from a modem processor or from a MAP after initializing the dual access memory;
a second step of deciding whether the data is normally written or read on a predetermined position of the dual access memory or not;
a third step of examining the storing area of the dual access memory in case that a predetermined time which is set in advance passed over;
a fourth step of reading the data stored in the dual access memory whenever an indicator is changed as a result of the examination; and
a fifth step of deciding whether the data is normally read or not.

10. The method of claim 9, wherein the second step decides whether the data of a unit is normally stored on a predetermined position of the dual access memory or not by setting or resetting the indicator which represents the normal transmitting/receiving status of the data and by increasing the index which represents the number of data by 1.

11. The method of claim 9, wherein the indicator is stored in the dual access memory in order to identify whether the data is normally written or read in case that the data is written or read between the modem processor and the MAP.

12. The method of claim 9 further comprising a step of deciding whether the data is normally written or read or not by identifying the indicator representing the normal transmitting/receiving status of the data and the index representing the number of data with a predetermined period.

13. The method of claim 9, wherein the fifth step decides whether the data is normally read or not by setting or resetting the indicator representing the normal transmitting/receiving status of the data.
